(19) United States
(12) Patent Application Publication
(10) Pub. No.: US 2016/0059527 A1
(43) Pub. Date: Mar. 3, 2016

(54) LOW DIELECTRIC POLYIMIDE FILM AND MANUFACTURE THEREOF

(71) Applicant: Taimide Technology Incorporation, Hsinchu County (TW)

(72) Inventors: Chun-Ting Lai, Hsinchu Hsien (TW); Chih-Wei Lin, Hsinchu Hsien (TW)

(21) Appl. No.: 14/839,655

(22) Filed: Aug. 28, 2015

(30) Foreign Application Priority Data
Aug. 29, 2014 (TW) 103129965

(51) Int. Cl. B32B 27/28; B32B 27/08; B32B 27/20; C08L 79/08

(52) U.S. Cl. CPC B32B 27/281; C08L 79/08; B32B 27/08; B32B 27/20; B32B 2250/24; B32B 2307/204; B32B 2457/08

(57) ABSTRACT

A polyimide film includes a first sub-layer and a second sub-layer connected with each other. The first sub-layer contains a first polyimide, and a particulate filler of fluorine-containing polymer distributed in the first polyimide. The second sub-layer includes a second polyimide similar or identical to the first polyimide. The first polyimide is derived from a first diamine component and a first dianhydride component, the first diamine component and/or the first dianhydride component containing fluorine atoms. The second sub-layer is derived from a second diamine component and a second dianhydride component, the second diamine component and/or the second dianhydride component also containing fluorine atoms.

### CROSS-REFERENCE TO RELATED APPLICATION

This application claims priority to Taiwan Patent Application No. 103129965 filed on Aug. 29, 2014, the disclosure of which is incorporated herein by reference.

### BACKGROUND

1. Field of the Invention

The present invention relates to a polyimide film and its manufacture, and specially relates to a polyimide film having low dielectric constant and high peel strength.

2. Description of the Related Art

Electronic products may require increasingly thinner, smaller and lightweight printed circuit boards (PCB). Moreover, because wireless internet and communication devices operate at higher frequency, efforts have been made to develop circuit boards capable of high transmission rates. Basic requirements for the materials of the circuit boards may include the ability to transfer data at a high rate, and prevent data alteration or interference during transmission.

Transmission speed in semiconductor devices may be mainly limited by the occurrence of delay between metal wires carrying the signals. In order to reduce the delay in signal transmission, an insulating layer having a low dielectric constant may be arranged between the wires, which can reduce capacitance coupling between the wires, enhance the operation speed and reduce noise interference. The insulating layer can block the flow of an electric current, and a lower dielectric constant can reduce the occurrence of undesirable stray capacitance. Moreover, the insulating material should have a dissipation factor that is as small as possible to minimize waste of electric energy.

Owing to its good thermal resistance, good chemical resistance, high mechanical strength, and high electrical resistance, polyimide may be used in electronics industry, for example, as material for making a printed circuit board. However, the dielectric constant and the dissipation factor of the conventional polyimide films may still be undesirably high for high-frequency applications. Furthermore, when the polyimide film is used as a base material for a flexible printed circuit board, a tearing resistance (i.e., peel strength) of the polyimide film with respect to a copper foil disposed thereon may be required so as that its assembly can endure processing steps such as drilling, electroplating, etching, thermal compression, surface treatment and the like.

Accordingly, there is a need for a polyimide film that can address the aforementioned issues and have desirable film characteristics.

### SUMMARY

The present application describes a polyimide film including a first sub-layer and a second sub-layer connected with each other. The first sub-layer contains a first polyimide, and a particulate filler of a fluorine-containing polymer distributed in the first sub-layer, wherein the first polyimide is derived from a first diamine component and a first dianhydride component, one or two of the first diamine component and the first dianhydride component containing fluorine atoms. The second sub-layer contains a second polyimide derived from a second diamine component and a second dianhydride component, one or two of the second diamine component and the second dianhydride component containing fluorine atoms.

### BRIEF DESCRIPTION OF THE DRAWINGS

FIG. 1 is a schematic view illustrating an embodiment of a polyimide film;

FIG. 2 is a schematic view illustrating a polyimide film obtained with Comparative Example 1 as described herein

FIG. 3A is a microscopic view of a polyimide film obtained with Example 1 as described herein; and

FIG. 3B is a microscopic view of a polyimide film obtained with Comparative Example 1 as described herein.

### DETAILED DESCRIPTION OF THE EMBODIMENTS

FIG. 1 is a schematic view illustrating an embodiment of a polyimide film 10. The polyimide film 10 can include a first sub-layer 11, a second sub-layer 12 and a third sub-layer 13. The first sub-layer 11 is sandwiched between the second sub-layer 12 and the third sub-layer 13, the second sub-layer 12 and the third sub-layer 13 respectively contacting with two opposite sides of the first sub-layer 11. The first sub-layer 11 contains a first polyimide 14 as a base material, and a particulate filler 15 distributed in the first polyimide 14, the particulate filler 15 being a polymer containing fluorine. The second sub-layer 12 and the third sub-layer 13 are respectively made of a second and a third polyimides that are free of filler of fluorine-containing polymer.

Referring to FIG. 1, for illustration purpose, the respective boundary lines 1A and 1B (shown as phantom lines) are drawn to facilitate the representation of the different sub-layers in the polyimide film 10. Actually, the base material of the sub-layers 11, 12 and 13 may be composed of substantially similar or identical polyimides, i.e., the first, second and third polyimide of the first, second and third sub-layers 11, 12 and 13 may be similar or identical so that there is no structure discontinuity between the first and second sub-layers 11 and 12 and between the first and third sub-layers 11 and 13, respectively. In other words, the entire polyimide film 10 may be viewed as a single layer, i.e., the polyimide film 10 is mainly composed of polyimide at a microscopic level, and the molecular structure of the polyimide can be substantially continuous across the boundary line 1A between the first sub-layer 11 and the second sub-layer 12, and across the boundary line 1B between the first sub-layer 11 and the third sub-layer 13.

The first polyimide forming the base material of the first sub-layer 11 may be derived from a first diamine component and a first dianhydride component, the first diamine component and/or the first dianhydride component (i.e., at least one of the first diamine component and the first dianhydride component) containing fluorine atoms. The second polyimide forming the second sub-layer 12 may be derived from a second diamine component and a second dianhydride component, at least one of the second diamine component and the second dianhydride component containing fluorine atoms.

“Fluorine ratio” as used herein is a percentage derived from the molar number of fluorine atoms contained in one reacting component (i.e., diamine or dianhydride component) divided by a total molar number of the same reacting component (i.e., the total molar number of diamine or dianhydride component). If the diamine component or the dianhydride component includes a combination of several species (e.g., the first diamine component may include multiple diamine species), then the total molar number is the sum of the molar number of each monomer species.

In some embodiments, the first diamine component used for forming the first polyimide contain fluorine atoms in a quantity greater than about 25 mol % based on the total molar number of the first diamine component, such as 26 mol %, 27 mol %, 30 mol %, 32 mol %, 34 mol %, 35 mol %, or any intermediate values in any ranges defined between any of the aforementioned values. In this case, the first dianhydride component can include, without limitation, dianhydride monomers without fluorine or dianhydride monomers containing fluorine. In some embodiments, the fluorine ratio may range from 25 mol % to 40 mol %, preferably from 25 mol % to 35 mol %.

In at least an embodiment, the fluorine ratio in the first diamine component used for forming the first polyimide is greater than about 25 mol %, and the second diamine component used for forming the second polyimide contains fluorine in a quantity equal to or greater than about 15 mol % based on the total molar number of the second diamine component, such as 15 mol %, 17 mol %, 20 mol %, 25 mol %, 30 mol %, 35 mol %, or any intermediate values defined in any ranges defined between any of the aforementioned values.

According to another embodiment, the fluorine ratio in the first diamine component used for forming the first polyimide is greater than about 25 mol %, and the second dianhydride component used for forming the second polyimide contains fluorine atoms. The fluorine ratio in the second dianhydride component is equal to or greater than about 10 mol % based on the total molar number of the second dianhydride component, such as 10 mol %, 12 mol %, 15 mol %, 17 mol %, 20 mol %, 22 mol %, 24 mol %, 25 mol %, or any intermediate values in any ranges defined between any of the aforementioned values.

In some embodiments, the first dianhydride component used for forming the first polyimide contains fluorine atoms in a quantity equal to or greater than about 20 mol % based on the total molar number of the first dianhydride component, such as 20 mol %, 21 mol %, 22 mol %, 23 mol %, 24 mol %, 25 mol %, or any intermediate values in any ranges defined between any of the aforementioned values. In this case, the first diamine component can include, without limitation, diamine monomers with no fluorine or diamine monomers containing fluorine. In some embodiments, the fluorine ratio in the first dianhydride component may range from 20 mol % to 35 mol %, and preferably from 20 mol % to 25 mol %.

In other embodiments, the fluorine ratio in the first dianhydride component used for forming the first polyimide is greater than about 20 mol %, and the second diamine component used for forming the second polyimide contains fluorine atoms in a quantity equal to or greater than about 15 mol % based on the total molar number of the second diamine component, such as 15 mol %, 17 mol %, 20 mol %, 25 mol %, 30 mol %, 35 mol %, or any intermediate values in any ranges defined between any of the aforementioned values.

In yet other embodiments, the fluorine ratio in the first dianhydride component used for forming the first polyimide is greater than about 20 mol %, and the second dianhydride component used for forming the second polyimide contains fluorine in a quantity equal to or greater than about 10 mol % based on the total molar number of the second dianhydride component, such as 10 mol %, 15 mol %, 20 mol %, 25 mol %, or any intermediate values in any ranges defined between any of the aforementioned values.

In some embodiments, the second sub-layer 12 and the third sub-layer 13 can contain the same polyimide composition, i.e., the second polyimide is the same as the third polyimide. In other embodiments, the second sub-layer 12 may contain a polyimide similar but not exactly identical to that of the third sub-layer 13, e.g., monomers used for forming the second polyimide are partially identical to those used for forming the third polyimide, or the used monomers may have similar structures (e.g., aromatic rings).

In the polyimide film described herein, the diamine component used for forming each of the sub-layers 11, 12 and 13 can be selected from the group consisting of 4,4′-oxydianiline (4,4′-ODA), phenylenediamine (p-PDA), 2,2′-bis(trifluoromethyl)benzidine (TFMB), 1,3-bis(4-amino-phenoxy)benzene (TPER), 1,4-bis(4-aminophenoxy)benzene (TPEQ), 2,2′-dimethyl[1,1′-biphenyl]-4,4′-diamine (m-TB-HG), 1,3′-Bis(3-aminophenoxy)benzene (APBN), 3,5-diamino benzotrifluoride (DABTF), 2,2′-bis[4-(4-aminophenoxy)phenyl]propane (BAPP), 6-amino-2-(4-aminophenyl)benzoxazole (6PBOA), 5-amino-2-(4-aminophenyl)benzoxazole (5PBOA), 2,2-Bis(4-aminophenyl)hexafluoropropane (BIS-A-AF), 3,4-diaminofluoro-benzene, 2-(trifluoromethyl)-1,4-phenylenediamine, 4-trifluoromethyl-1,2-phenylenediamine, 1,2-diamine-4,5-difluorobenzene and the like, which can be used individually or in combination.

The dianhydride component used for forming each of the sub-layers 11, 12 and 13 can be selected from the group consisting of pyromellitic dianhydride (PMDA), 3,3′,4,4′-biphenyltetracarboxylic dianhydride (BPDA), [4-(3,4dicarboxyphenoxy)phenyl] propane dianhydride (BPADA), 2,2′-bis-(3,4-dicarboxyphenyl)hexafluoropropane dianhydride (6FDA), 4,4-oxydiphthalic anhydride (ODPA), benzophenonetetracarboxylic dianhydride (BTDA), 3,3′,4,4′-dicyclo-hexyltetracarboxylic acid dianhydride (HBPDA) and 3,3′,4,4′-diphenylsulfonetertracarboxylic dianhydride (DSDA), which can be used individually or in combination.

The fluorine-containing polymer distributed as particulate filler 15 in the first sub-layer 11 can include, without limitation, fluorocarbons. More specifically, the particulate filler 15 can be fluorinated polyalkene, fluoro-substituent polyalkane, fluoro-substituent alkoxide, chlorofluorocarbons and the like.

In some embodiments, the particulate filler 15 is selected from the group consisting of polyvinylfluoride (PVF), polyfluorinated vinylidene (PVDF) polymer, polytetrafluoroethylene (PTFE), polyfluorinated ethylene propylene (FEP), perfluoropolyether (PEPE), PFSA polymer, perfluoroalkoxy (PFA) polymer, chlorotrifluoroethylene (CTFE) polymer and ethylene chlorotrifuloroethylene (ECTFE) polymer, which ca be used individually or in combination.

In at least one embodiment, the weight ratio of the particulate filler 15 may range from about 30 wt % to about 45 wt % based on the total weight of the first sub-layer 11, such as 30 wt %, 31 wt %, 32.5 wt %, 35 wt %, 37.5 wt %, 39 wt %, 40 wt %, 42 wt %, 43 wt %, 44 wt %, 45 wt %, or any intermediate values in any ranges defined between any of the aforementioned values. In some embodiments, the weight ratio of the fluorine-containing polymer may range from 30 wt % to 40 wt %.

The fluorine-containing polymer is in a powder form having an average particle diameter or size from 1 μm to 10 μm, e.g., 0.5 μm, 1 μm, 2.5 μm, 5 μm, 7.5 μm, 10 μm, or any intermediate values in any ranges defined between any of the aforementioned values. In some embodiments, the average particle diameter of the fluorine-containing polymer particles is from 1 μm to 5 μm. In other embodiments, the average particle diameter of the fluorine-containing polymer particles ranges from 5 μm to 10 μm. In still other embodiments, the average particle diameter of the fluorine-containing polymer particles is between 2 μm and 8 μm.

The polyimide film 10 shown in FIG. 1 can be fabricated according to the following method. First, selected diamine and dianhydride monomers for forming the first polyimide are mixed in a solvent to form a first polyamic acid solution. Particles of fluorine-containing polymer then are added as a filler and mixed evenly to form a first reaction solution for the first polyimide of the first sub-layer 11. Selected diamine and dianhydride monomers for forming the second polyimide are mixed in a solvent to form a second polyamic acid reaction solution of the second polyimide. The second reaction solution of the second polyimide may be free of fluorine-containing polymer particles. The same reaction solution may be used for forming the second polyimide of the second sub-layer 12 and the third polyimide of the third sub-layer 13, or a different polyamic acid solution may be separately applied for forming the third polyimide.

In some embodiments, the diamine monomers and dianhydride monomers as described previously may undergo a condensation reaction at a substantially equimolar ratio to form the polyimide.

Co-extrusion may be employed so as to apply three layers of the reaction solutions described previously on a support member (e.g., roller, sliding belt, looped belt, and the like), which is then heated at a temperature between 200° C. and 650° C. to form the polyimide film.

The polyimide films described herein may be formed through thermal conversion or chemical conversion. When chemical conversion is applied, a dehydrating agent and a catalyst may be added in the reaction solution before co-extrusion is performed. Suitable solvents, dehydrating agents and catalysts are known in the relevant art. The solvent may be an aprotic polar solvent, e.g., dimethylacetamide (DMAC), N,N′-dimethyl-formamide (DMF), N-methyl-2-pyrrolidone (NMP), dimethyl sulfoxide (DMSO), tetra-methylene sulfone, N,N′-dimethyl-N,N′-propylene urea (DMPU), and the like. The dehydrating agent may be an aliphatic anhydride (e.g., acetic anhydride and propionic anhydride), aromatic anhydride (e.g., benzoic acid anhydride and o-phthalic anhydride), etc. The catalyst may be tertiary heterocyclic amines (e.g., picoline, pyridine and the like), tertiary aliphatic amines (e.g., TEA and the like), tertiary aromatic amines (e.g., dimethylaniline), etc. The molar ratio of polyamic acid:dehydrating agent:catalyst may be 1:2:1, i.e., 2 moles of dehydrating agent and 1 mole of catalyst per mole of polyamic acid.

According to an embodiment, h1 designates the thickness of the first sub-layer 11, h2 designates the thickness of the second sub-layer 12, h3 designates the thickness of the third sub-layer 13, and each of the ratios h2/h1 and h3/h1 is respectively less than 1/10, e.g., 1/12, 1/14, 1/16, 1/18, 1/20, or any intermediate values in any ranges defined between any of the aforementioned values. According to another embodiment, the second and third sub-layers 12 and 13 have a same thickness, h4=h2+h3 represents the sum of the respective thickness of the second and third sub-layers 12 and 13, and the ratio h4/h1 is less than 1/5, e.g., 1/6, 1/7, 1/8, 1/9, 1/10, or any intermediate values in any ranges defined between any of the aforementioned values.

The polyimide films described herein can have at least one of the following properties: a dielectric constant Dₖ lower than 3.04, a dissipation factor D_{f} lower than 0.0107, a peel strength greater than 0.41 kgf/cm.

The dielectric constant Dₖ can be lower than 3.04, e.g., lower than 3.02, lower than 3.0, lower than 2.9, etc.

The dissipation factor D_{f} can be lower than 0.0107, e.g., lower than 0.0105, lower than 0.01, lower than 0.009, lower than 0.007, etc.

The peel strength can be higher than 0.41 kgf/cm, e.g., greater than 0.43 kgf/cm, 0.45 kgf/cm, 0.5 kgf/cm, 0.6 kgf/cm, etc.

Methods of fabricating the polyimide films are further described with reference to the following examples.

### EXAMPLE 1

Preparation of a First Reaction Solution:

15.661 kg of TFMB and 132.6 kg of DMAc solvent are put in a 200 L reactor. The mixture is stirred at a temperature of 30° C. until complete dissolution of TFMB in the solvent, and 21.63 kg of 6FDA is then added therein. The weight ratio of the reacting monomers is 22 wt % of the total weight of the reaction solution. Then 15.98 kg of PTFE powder (corresponding to 30 wt % of the total weight of the reacting monomers) is added in the mixture, which is continuously agitated and undergoes reaction for 24 hrs at a temperature of 25° C. to obtain a first reaction solution for the first polyimide having a rotational viscosity of 200,000 cps at a temperature of 25° C.

Preparation of a Second Reaction Solution:

A second reaction solution for the second polyimide can be prepared like the first reaction solution described previously, except that no PTFE is incorporated in the second reaction solution.

Preparation of a Polyimide Film:

Co-extrusion is applied to form a sandwich structure in which the central first sub-layer of the sandwich structure is formed with the first reaction solution, and the second and third sub-layers at two opposite sides of the first sub-layer are respectively formed with the second reaction solution. A polyimide film can be thereby fabricated according to a continuous process, the total thickness of the polyimide film being 24 μm, the thickness of the first sub-layer being 20 μm, and the respective thicknesses of the second and third sub-layers at two opposite sides of the first sub-layer being 2 μm.

### EXAMPLE 2

A polyimide film is prepared like in Example 1, except that the reacting monomers of the first reaction solution are replaced with 19.492 kg of TFMB and 17.819 kg of BPDA, the weight ratio of the reacting monomers being 22 wt % of the total weight of the first reaction solution. The second reaction solution used in Example 2 is similar to the second reaction solution used in Example 1.

### EXAMPLE 3

A polyimide film is prepared like in Example 1, except that the reacting monomers of the first reaction solution are replaced with 11.61 kg of ODA and 25.66 kg of 6FDA, the weight ratio of the reacting monomers being 22 wt % of the total weight of the first reaction solution. The second reaction solution used in Example 3 is similar to the second reaction solution used in Example 1.

### EXAMPLE 4

A polyimide film is prepared like in Example 1, except that the reacting monomers of the second reaction solution are replaced with 19.492 kg of TFMB and 17.819 kg of BPDA, the weight ratio of the reacting monomers being 22 wt % of the total weight of the second reaction solution. The first reaction solution used in Example 4 is similar to the first reaction solution used in Example 1.

### EXAMPLE 5

A polyimide film is prepared like in Example 1, except that the reacting monomers of the second reaction solution are replaced with 11.61 kg of ODA and 25.66 kg of 6FDA, the weight ratio of the reacting monomers being 22 wt % of the total weight of the second reaction solution. The first reaction solution used in Example 5 is similar to the first reaction solution used in Example 1.

### EXAMPLE 6

A polyimide film is prepared like in Example 1, except that the reacting monomers of the second reaction solution are replaced with 19.492 kg of TFMB and 17.819 kg of BPDA, the weight ratio of the reacting monomers being 22 wt % of the total weight of the second reaction solution. The first reaction solution used in Example 6 is similar to the first reaction solution used in Example 2.

### EXAMPLE 7

A polyimide film is prepared like in Example 1, except that the reacting monomers of the second reaction solution are replaced with 11.61 kg of ODA and 25.66 kg of 6FDA, the weight ratio of the reacting monomers being 22 wt % of the total weight of the second reaction solution. The first reaction solution used in Example 7 is similar to the first reaction solution used in Example 2.

### EXAMPLE 8

A polyimide film is prepared like in Example 1, except that the reacting monomers of the second reaction solution are replaced with 19.492 kg of TFMB and 17.819 kg of BPDA, the weight ratio of the reacting monomers being 22 wt % of the total weight of the second reaction solution. The first reaction solution used in Example 8 is similar to the first reaction solution used in Example 3.

### EXAMPLE 9

A polyimide film is prepared like in Example 1, except that the reacting monomers of the second reaction solution are replaced with 11.61 kg of ODA and 25.66 kg of 6FDA, the weight ratio of the reacting monomers being 22 wt % of the total weight of the second reaction solution. The first reaction solution used in Example 9 is similar to the first reaction solution used in Example 3.

### EXAMPLE 10

Preparation of the First Reaction Solution:

13.419 kg of TFMB, 4.718 kg of ODA and 132.6 kg of DMAc are put in a 200 L reactor. The mixture is stirred at a temperature of 30° C. until complete dissolution of TFMB and ODA, and 19.167 kg of BPDA is then added therein. The weight ratio of the reacting monomers is 22 wt % of the total weight of the reaction solution. Then 15.99 kg of PTFE powder (corresponding to 30 wt % of the total weight of the reacting monomers) is added in the mixture, which is continuously agitated and undergoes reaction for 24 hrs at a temperature of 25° C. to obtain the first reaction solution having a rotational viscosity of 200,000 cps at a temperature of 25° C.

Preparation of the Second Reaction Solution:

7.401 kg of TFMB, 9.392 kg of ODA and 132.6 kg of DMAc are put in a 200 L reactor. The mixture is stirred at a temperature of 30° C. until complete dissolution of TFMB and ODA, and 20.503 kg of BPDA is then added therein. The weight ratio of the reacting monomers is 22 wt % of the total weight of the second reaction solution. The obtained mixture is continuously agitated and undergoes reaction for 24 hrs at a temperature of 25° C. to obtain the second reaction solution having a rotational viscosity of 200,000 cps at a temperature of 25° C.

Preparation of a Polyimide Film:

A polyimide film can be prepared through a co-extrusion process as described previously and by using the first and second reaction solutions of Example 10. The formed polyimide film can have three sub-layers like in Example 1.

### EXAMPLE 11

A polyimide film is prepared like in Example 10, except that the reacting monomers of the second reaction solution are replaced with 13.799 kg of ODA, 9.807 kg of 6FDA and 13.692 kg of BPDA, the weight ratio of the reacting monomers being 22 wt % of the total weight of the second reaction solution. The first reaction solution used in Example 11 is similar to the first reaction solution used in Example 10.

### EXAMPLE 12

A polyimide film is prepared like in Example 10, except that the reacting monomers of the first reaction solution are replaced with 12.33 kg of ODA, 20.539 kg of 6FDA and 4.441 kg of BPDA, the weight ratio of the reacting monomers being 22 wt % of the total weight of the first reaction solution. The second reaction solution used in Example 12 is similar to the second reaction solution used in Example 10.

### EXAMPLE 13

A polyimide film is prepared like in Example 10, except that the reacting monomers of the second reaction solution are replaced with 13.799 kg of ODA, 9.807 kg of 6FDA and 13.692 kg of BPDA, the weight ratio of the reacting monomers being 22 wt % of the total weight of the second reaction solution. The first reaction solution used in Example 13 is similar to the first reaction solution used in Example 12.

### COMPARATIVE EXAMPLE 1

A polyimide film is prepared like in Example 1, except that the reacting monomers of the second reaction solution are replaced with 15.142 kg of ODA and 22.147 kg of BPDA, the weight ratio of the reacting monomers being 22 wt % of the total weight of the second reaction solution. The first reaction solution used in Comparative Example 1 is similar to the first reaction solution used in Example 1.

### COMPARATIVE EXAMPLE 2

A polyimide film is prepared like in Example 1, except that the reacting monomers of the second reaction solution are replaced with 15.142 kg of ODA and 22.147 kg of BPDA, the weight ratio of the reacting monomers being 22 wt % of the total weight of the second reaction solution. The first reaction solution used in Comparative Example 2 is similar to the first reaction solution used in Example 2.

### COMPARATIVE EXAMPLE 3

A polyimide film is prepared like in Example 1, except that the reacting monomers of the second reaction solution are replaced with 15.142 kg of ODA and 22.147 kg of BPDA, the weight ratio of the reacting monomers being 22 wt % of the total weight of the second reaction solution. The first reaction solution used in Comparative Example 3 is similar to the first reaction solution used in Example 3.

### COMPARATIVE EXAMPLE 4

A polyimide film is prepared like in Example 1, except that the reacting monomers of the first reaction solution are replaced with 15.142 kg of ODA and 22.147 kg of BPDA, the weight ratio of the reacting monomers being 22 wt % of the total weight of the first reaction solution. Moreover, the reacting monomers of the second reaction solution are replaced with 19.492 kg of TFMB and 17.819 kg of BPDA, the weight ratio of the reacting monomers being 22 wt % of the total weight of the second reaction solution.

### COMPARATIVE EXAMPLE 5

A polyimide film is prepared like in Example 1, except that the reacting monomers of the second reaction solution are replaced with 11.61 kg of ODA and 25.66 kg of 6FDA, the weight ratio of the reacting monomers being 22 wt % of the total weight of the second reaction solution. Moreover, the first reaction solution used in Comparative Example 5 is similar to the first reaction solution used in Comparative Example 4.

### COMPARATIVE EXAMPLE 6

A polyimide film is prepared like in Example 1, except that the reacting monomers of the second reaction solution are replaced with 15.661 kg of TFMB and 21.63 kg of 6FDA, the weight ratio of the reacting monomers being 22 wt % of the total weight of the second reaction solution. Moreover, the first reaction solution used in Comparative Example 6 is similar to the first reaction solution used in Comparative Example 4.

### COMPARATIVE EXAMPLE 7

A polyimide film is prepared like in Example 1, except that the reacting monomers of the second reaction solution are replaced with 15.142 kg of ODA and 22.147 kg of BPDA, the weight ratio of the reacting monomers being 22 wt % of the total weight of the second reaction solution. Moreover, the first reaction solution used in Comparative Example 7 is similar to the first reaction solution used in Comparative Example 4.

### COMPARATIVE EXAMPLE 8

Preparation of the First Reaction Solution:

10.415 kg of TFMB, 7.051 kg of ODA and 132.6 kg of DMAc are put in a 200 L reactor. The mixture is stirred at a temperature of 30° C. until complete dissolution of TFMB and ODA, and 19.834 kg of BPDA is then added therein. The weight ratio of the reacting monomers is 22 wt % of the total weight of the first reaction solution. Then 15.99 kg of PTFE powder (corresponding to 30 wt % of the total weight of the reacting monomers) is added in the mixture, which is continuously agitated and undergoes reaction for 24 hrs at a temperature of 25° C. to obtain the first reaction solution having a rotational viscosity of 200,000 cps at a temperature of 25° C.

Preparation of the Second Reaction Solution:

7.401 kg of TFMB, 9.392 kg of ODA and 132.6 kg of DMAc are put in a 200 L reactor. The mixture is stirred at a temperature of 30° C. until complete dissolution of TFMB and ODA, and 20.503 kg of BPDA is then added therein. The weight ratio of the reacting monomers is 22 wt % of the total weight of the second reaction solution. The obtained mixture is continuously agitated and undergoes reaction for 24 hrs at a temperature of 25° C. to obtain the second reaction solution having a rotational viscosity of 200,000 cps at a temperature of 25° C.

Preparation of the Polyimide Film:

A polyimide film can be prepared through a co-extrusion process as described previously and by using the first and second reaction solutions of Comparative Example 8. The formed polyimide film can have three sub-layers like in Example 1.

### COMPARATIVE EXAMPLE 9

A polyimide film is prepared like in Example 1, except that the reacting monomers of the second reaction solution are replaced with 13.799 kg of ODA, 9.807 kg of 6FDA and 13.692 kg of BPDA, the weight ratio of the reacting monomers being 22 wt % of the total weight of the second reaction solution. Moreover, the first reaction solution used in Comparative Example 9 is similar to the first reaction solution used in Comparative Example 8.

### COMPARATIVE EXAMPLE 10

Preparation of the First Reaction Solution:

13.075 kg of ODA and 132.6 kg of DMAc are put in a 200 L reactor. The mixture is stirred at a temperature of 30° C. until complete dissolution of ODA, and 15.1 kg of 6FDA and 9.129 kg of BPDA are then added therein. The weight ratio of the reacting monomers is 22 wt % of the total weight of the first reaction solution. Then 15.99 kg of PTFE powder (corresponding to 30 wt % of the total weight of the reacting monomers) is added in the mixture, which is continuously agitated and undergoes reaction for 24 hrs at a temperature of 25° C. to obtain the first reaction solution having a rotational viscosity of 200,000 cps at a temperature of 25° C.

Preparation of the Second Reaction Solution:

The reacting monomers are replaced with 7.401 kg of TFMB, 9.392 kg of ODA and 20.503 kg of BPDA. The weight ratio of the reacting monomers is 22 wt % of the total weight of the second reaction solution.

Preparation of the Polyimide Film:

A polyimide film having three sub-layers can be prepared through a co-extrusion process as described previously and by using the first and second reaction solutions of Comparative Example 10.

### COMPARATIVE EXAMPLE 11

A polyimide film is prepared like in Example 1, except that the reacting monomers of the second reaction solution are replaced with 13.799 kg of ODA, 9.807 kg of 6FDA and 13.692 kg of BPDA, the weight ratio of the reacting monomers being 22 wt % of the total weight of the second reaction solution. The first reaction solution used in Comparative Example 11 is similar to the first reaction solution used in Comparative Example 10.

### COMPARATIVE EXAMPLE 12

A polyimide film is prepared like in Example 1, except that the reacting monomers of the second reaction solution are replaced with 4.841 kg of TFMB, 11.381 kg of ODA and 21.072 kg of BPDA, the weight ratio of the reacting monomers being 22 wt % of the total weight of the second reaction solution. The first reaction solution used in Comparative Example 12 is similar to the first reaction solution used in Example 10.

### COMPARATIVE EXAMPLE 13

A polyimide film is prepared like in Example 1, except that the reacting monomers of the second reaction solution are replaced with 14.481 kg of ODA, 4.824 kg of 6FDA and 17.988 kg of BPDA, the weight ratio of the reacting monomers being 22 wt % of the total weight of the second reaction solution. The first reaction solution used in Comparative Example 13 is similar to the first reaction solution used in Example 10.

### COMPARATIVE EXAMPLE 14

A polyimide film is prepared like in Example 1, except that the reacting monomers of the second reaction solution are replaced with 4.841 kg of TFMB, 11.381 kg of ODA and 21.072 kg of BPDA, the weight ratio of the reacting monomers being 22 wt % of the total weight of the second reaction solution. The first reaction solution used in Comparative Example 14 is similar to the first reaction solution used in Example 12.

### COMPARATIVE EXAMPLE 15

A polyimide film is prepared like in Example 1, except that the reacting monomers of the second reaction solution are replaced with 14.481 kg of ODA, 4.824 kg of 6FDA and 17.988 kg of BPDA, the weight ratio of the reacting monomers being 22 wt % of the total weight of the second reaction solution. The first reaction solution used in Comparative Example 15 is similar to the first reaction solution used in Example 12.

The polyimide films obtained according to the aforementioned Examples and Comparative Examples are tested to measure certain properties described below, the results of the testing being listed in Table 1.

Dielectric Constant Dₖ and Dissipation Factor D_{f}:

Samples of polyimide films to be tested are soaked in deionized water for about 10 minutes, dried in a furnace at a temperature of 110° C. for about 30 minutes, and then the Dₖ/D_{f} of the samples are measured with a precision impedance analyzer (Agilent 4294A).

Peel Strength:

According to the IPC-TM650-2.4.9 standard test method of 90° peel strength, an universal mechanical testing machine (Hounsfield H10K-S) is used to test the peel strength of samples of the polyimide films. The following steps are performed in this testing.

First, a hot-pressed 3L-FCCL substrate is prepared with a polyimide film (9 cm×13 cm), an adhesive (8 cm×12 cm, model no: BH25EL3 purchased from TAIFLEX Scientific Co., Ltd.) and a copper foil (9 cm×13 cm). The adhesive is applied on a surface of the polyimide film, and then the copper foil is placed on the adhesive. Then hot pressing is carried out by a hot press machine at a temperature of 190° C. and under a pressure of 20 kgf/cm2, pre-heating taking 10 seconds and the pressure is applied for 2 minutes. Subsequently, the hot-pressed layers are cured at a temperature of 160° C. for 1 hour in a furnace, after which a polyimide substrate with a single-layer copper foil is obtained.

The polyimide substrate with the single-layer copper foil is divided into strips, each strip having a length equal to 13 cm and a width equal to 0.33 cm and is separated with a 0.33 cm interval. These strips form multiple samples for testing. The copper foil in the interval region is removed, and a blade is used to create a cut of about 0.5 cm through the bonding region of the copper foil with the polyimide film in each sample. Then the outer side of the polyimide layer on the substrate is adhered onto a pinch roller, and a metal clip is used to clip the copper foil at the cut region on a universal tension testing machine. When testing is performed, the pinch roller rotates at speed of about 50 mm/min at a temperature of 25±3° C. This arrangement can test the force needed to peel the copper foil off from the polyimide film at an angle of 90°.

The testing results are shown in Table 1.

TABLE 1
testing results

| | 1^{st} reaction solution for the first polyimide | | | 2^{nd} reaction solution for the second polyimide | | | | | |
|---|---|---|---|---|---|---|---|---|---|
| | | Fluorine | Fluorine | | Fluorine | Fluorine | | | |
| | | content in | content in | | content in | content in | Polyimide film properties | | |
| | | diamine | dianhydride | | diamine | dianhydride | | | Peel |
| | | component | component | | component | component | | | strength |
| | Monomers | (mol %) | (mol %) | Monomers | (mol %) | (mol %) | Dₖ | D_{f} | (kgf/cm) |
| Example | | | | | | | | | |
| 1 | TFMB/6FDA | 34 | 24 | TFMB/6FDA | 34 | 24 | 2.63 | 0.0063 | 0.52 |
| 2 | TFMB/BPDA | 34 | 0 | TFMB/6FDA | 34 | 24 | 2.75 | 0.0074 | 0.41 |
| 3 | ODA/6FDA | 0 | 24 | TFMB/6FDA | 34 | 24 | 2.72 | 0.0071 | 0.53 |
| 4 | TFMB/6FDA | 34 | 24 | TFMB/BPDA | 34 | 0 | 2.67 | 0.0069 | 0.49 |
| 5 | TFMB/6FDA | 34 | 24 | ODA/6FDA | 0 | 24 | 2.65 | 0.0074 | 0.61 |
| 6 | TFMB/BPDA | 34 | 0 | TFMB/BPDA | 34 | 0 | 2.74 | 0.0075 | 0.55 |
| 7 | TFMB/BPDA | 34 | 0 | ODA/6FDA | 0 | 24 | 2.79 | 0.0079 | 0.64 |
| 8 | ODA/6FDA | 0 | 24 | TFMB/BPDA | 34 | 0 | 2.78 | 0.0075 | 0.48 |
| 9 | ODA/6FDA | 0 | 24 | ODA/6FDA | 0 | 24 | 2.83 | 0.0081 | 0.45 |
| 10 | TFMB/ODA/ | 25 | 0 | TFMB/ODA/ | 15 | 0 | 2.94 | 0.0093 | 0.62 |
| | BPDA | | | BPDA | | | | | |
| 11 | TFMB/ODA/ | 25 | 0 | ODA/6FDA/ | 0 | 10 | 2.83 | 0.0087 | 0.46 |
| | BPDA | | | BPDA | | | | | |
| 12 | ODA/6FDA/ | 0 | 20 | TFMB/ODA/ | 15 | 0 | 2.85 | 0.0081 | 0.58 |
| | BPDA | | | BPDA | | | | | |
| 13 | ODA/6FDA/ | 0 | 20 | ODA/6FDA/ | 0 | 10 | 2.93 | 0.0094 | 0.55 |
| | BPDA | | | BPDA | | | | | |
| Comparative | | | | | | | | | |
| Example | | | | | | | | | |
| 1 | TFMB/6FDA | 34 | 24 | ODA/BPDA | 0 | 0 | 2.82 | 0.0089 | 0.12 |
| 2 | TFMB/BPDA | 34 | 0 | ODA/BPDA | 0 | 0 | 2.88 | 0.0095 | 0.09 |
| 3 | ODA/6FDA | 0 | 24 | ODA/BPDA | 0 | 0 | 2.87 | 0.0084 | 0.06 |
| 4 | ODA/BPDA | 0 | 0 | TFMB/BPDA | 34 | 0 | 3.07 | 0.0113 | 0.19 |
| 5 | ODA/BPDA | 0 | 0 | ODA/6FDA | 0 | 24 | 3.04 | 0.0107 | 0.17 |
| 6 | ODA/BPDA | 0 | 0 | TFMB/6FDA | 34 | 24 | 3.11 | 0.0121 | 0.08 |
| 7 | ODA/BPDA | 0 | 0 | ODA/BPDA | 0 | 0 | 3.14 | 0.0128 | 0.89 |
| 8 | TFMB/ODA/ | 20 | 0 | TFMB/ODA/ | 15 | 0 | 3.17 | 0.0114 | 0.52 |
| | BPDA | | | BPDA | | | | | |
| 9 | TFMB/ODA/ | 20 | 0 | ODA/6FDA/ | 0 | 10 | 3.12 | 0.0113 | 0.63 |
| | BPDA | | | BPDA | | | | | |
| 10 | ODA/6FDA/ | 0 | 15 | TFMB/ODA/ | 15 | 0 | 3.07 | 0.0134 | 0.49 |
| | BPDA | | | BPDA | | | | | |
| 11 | ODA/6FDA/ | 0 | 15 | ODA/6FDA/ | 0 | 10 | 3.05 | 0.0127 | 0.58 |
| | BPDA | | | BPDA | | | | | |
| 12 | TFMB/ODA/ | 25 | 0 | TFMB/ODA/ | 10 | 0 | 3.09 | 0.0124 | 0.72 |
| | BPDA | | | BPDA | | | | | |
| 13 | TFMB/ODA/ | 25 | 0 | ODA/6FDA/ | 0 | 5 | 3.16 | 0.0119 | 0.69 |
| | BPDA | | | BPDA | | | | | |
| 14 | ODA/6FDA/ | 0 | 20 | TFMB/ODA/ | 10 | 0 | 3.18 | 0.0115 | 0.46 |
| | BPDA | | | BPDA | | | | | |
| 15 | ODA/6FDA/ | 0 | 20 | ODA/6FDA/ | 0 | 5 | 3.12 | 0.0123 | 0.65 |
| | BPDA | | | BPDA | | | | | |

The polyimide films described herein can have a reduced dielectric constant Dₖ and a reduced dissipation factor D_{f} by adding a suitable amount of PTFE. Moreover, the application of co-extrusion technique associated with specific compositions for the first sub-layer, the second sub-layer and the third sub-layer allows to form a polyimide film that has relatively high peel strength.

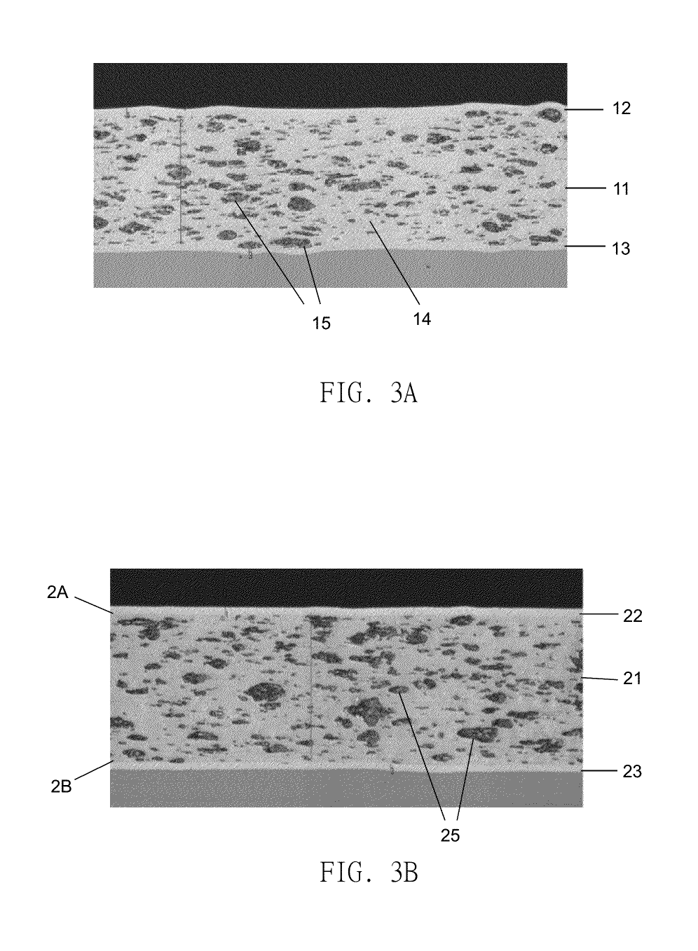

The polyimide films prepared according to Example 1 and Comparative Example 1 are observed with a confocal microscope (Model type VK-9500G2 purchased from Keyence, amplification factor: ×3000), and the structure of the polyimide film obtained with Example 1 is illustrated in FIGS. 1 and 3A. There is no obvious interface between the three sub-layers 11, 12 and 13 of the polyimide film 10, and the polyimide molecules extend almost continuously across the three sub-layers 11, 12 and 13. The thickness of the first sub-layer 11 can be approximately determined by observing the distribution range of the particulate filler 15 of fluorine-containing polymer. Based on these observations, the polyimide film obtained with Example 1 can be viewed as a single layer with respect to its polyimide molecular structure.

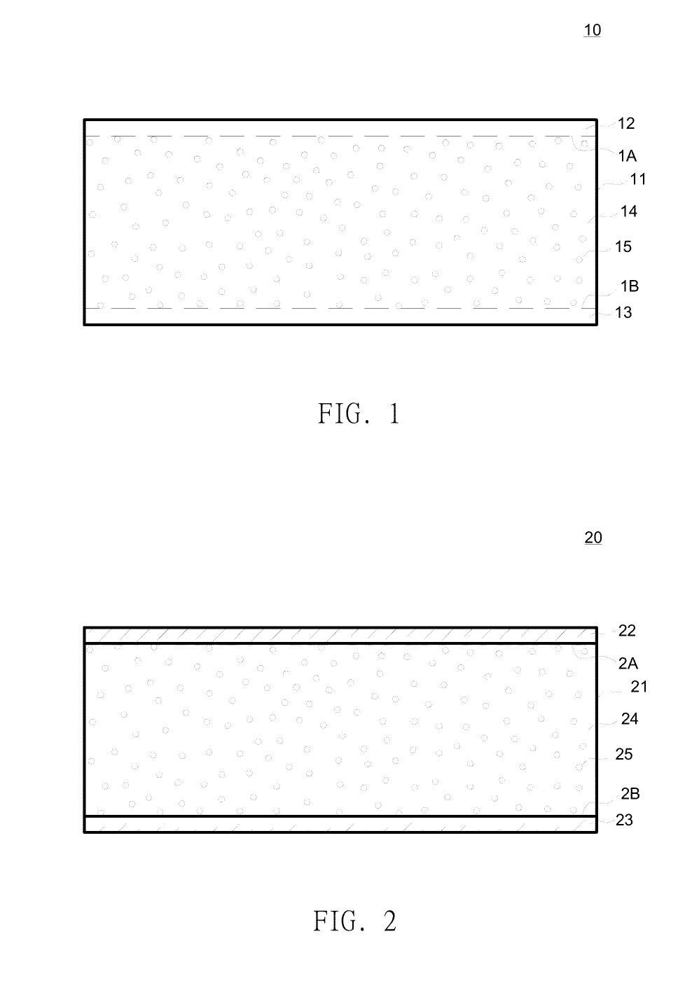

The polyimide film 20 obtained with Comparative Example 1 is shown in FIGS. 2 and 3B. It can be observed that the first sub-layer 21 of the polyimide film 20 contains a polyimide 24 as base material, and particulate filler 25 of fluorine-containing polymer dispersed in the polyimide 24. The polyimide molecular structure appears different in each of the sub-layers 21, 22 and 23 of the polyimide film 20, and there are distinct interface boundaries 2A and 2B between three sub-layers 21, 22 and 23. The interface boundaries 2A and 2B reflect discontinuities in the polyimide molecular structure. Accordingly, the polyimide film obtained with Comparative Example 1 is a multi-layer structure containing three distinctive sub-layers, and the peel strength is relatively low (0.12 kgf/cm), which means that the bonding force between the sub-layers is relatively weak owing to a difference in the polyimide structure across the different sub-layers. Under stress, that polyimide film may be easily separated or peeled at the interface between the sub-layers.

In contrast, the continuous distribution of the polyimide molecular structure in the polyimide film obtained with Example 1 can result in an enhanced peel strength (0.52 kgf/cm) and overcome the aforementioned peeling problem, which facilitates its application and manufacture process. While the polyimide film has a peel strength that makes it similar to a single layer, additives may be locally added (e.g., in at least one of the three sub-layers, such as the first sub-layer) for providing desirable functions.

Referring to Table 1, with respect to the polyimide film obtained with Comparative Example 1, the first polyimide of the first sub-layer is derived from monomers that all contain fluorine, and the second polyimide of the second sub-layer is derived from monomers containing no fluorine. The testing results obtained for Comparative Example 1 show that the peel strength of the polyimide film is undesirably small. In contrast, the polyimide films obtained with Examples 1, 4 and 5 can have an improved peel strength by using fluorinated monomers for forming each sub-layer of the polyimide film.

The testing results for Comparative Examples 2 and 3 show that when one of the diamine and dianhydride components of the first polyimide contain fluorine and all of the diamine and dianhydride components of the second polyimide contain no fluorine, the peel strength is also undesirably low. The testing results obtained for Examples 2, 3, 6, 7, 8 and 9 show that the peel strength of the polyimide film can be improved when each sub-layer of the polyimide film is respectively derived from reacting monomers that may include at least one fluorinated component.

Compared to Examples 1 to 9, the testing results of Comparative Examples 4 through 6 show that when all the monomers used for forming the first polyimide have no fluorine, and one of the diamine and dianhydride components of the second polyimide contains fluorine, the peel strength of the polyimide film is undesirably low, and the dielectric constant Dₖ and the dissipation factor D_{f} are undesirably high. Moreover, the testing results of Comparative Example 7 show that when both the first and second polyimide are derived from monomers having no fluorine, the dielectric constant Dₖ and the dissipation factor D_{f} are undesirably high.

When comparing the testing results of Example 10 against those of Comparative Example 8, and the testing results of Example 11 against those of Comparative Example 9, it can be observed that for a given monomer association of the first and second polyimide, the dielectric constant Dₖ and the dissipation factor D_{f} of the polyimide film are undesirably increased when the fluorine content in the diamine component of the first polyimide is less than 25 mol %.

When comparing the testing results of Example 12 against those of Comparative Example 10, and the testing results of Example 13 against those of Comparative Example 11, it can be observed that for a given monomer association of the first and second polyimide, the dielectric constant Dₖ and the dissipation factor D_{f} of the polyimide film are also undesirably increased when the fluorine content in the dianhydride component of the first polyimide is less than 20 mol %.

When comparing the testing results of Example 10 against those of Comparative Example 12, and the testing results of Example 12 against those of Comparative Example 14, it can be observed that for a given monomer association of the first and second polyimide, the dielectric constant Dₖ and the dissipation factor D_{f} of the polyimide film are also undesirably increased when the fluorine content in the diamine component of the second polyimide is less than 15 mol %.

When comparing the testing results of Example 11 against those of Comparative Example 13, and the testing results of Example 13 against those of Comparative Example 15, it can be observed that for a given monomer association of the first and second polyimide, the dielectric constant Dₖ and the dissipation factor D_{f} of the polyimide film are undesirably increased when the fluorine content in the dianhydride component of the second polyimide is less than 10 mol %.

According to the present disclosure, a polyimide film formed by co-extrusion can have multiple polyimide sub-layers, each of which being derived from monomers containing fluorine at specific quantities. The polyimide film exhibits a low dielectric constant and a low dissipation factor, and has a relatively high peel strength.

While various embodiments in accordance with the disclosed principles been described above, it should be understood that they are presented by way of example only, and are not limiting. Thus, the breadth and scope of exemplary embodiment(s) should not be limited by any of the above-described embodiments, but should be defined only in accordance with the claims and their equivalents issuing from this disclosure. Furthermore, the above advantages and features are provided in described embodiments, but shall not limit the application of such issued claims to processes and structures accomplishing any or all of the above advantages.

Realizations of the polyimide films and the method of their manufacture have been described in the context of particular embodiments. These embodiments are meant to be illustrative and not limiting. Many variations, modifications, additions, and improvements are possible. These and other variations, modifications, additions, and improvements may fall within the scope of the invention as defined in the claims that follow.

What is claimed is:

1. A polyimide film comprising:
a first sub-layer containing a first polyimide, and a particulate filler of a fluorine-containing polymer distributed in the first polyimide, wherein the first polyimide is derived from a first diamine component and a first dianhydride component, one or two of the first diamine component and the first dianhydride component containing fluorine atoms; and
a second sub-layer connected with the first sub-layer, the second sub-layer containing a second polyimide derived from a second diamine component and a second dianhydride component, one or two of the second diamine component and the second dianhydride component containing fluorine atoms.

2. The polyimide film according to claim 1, wherein the second sub-layer is free of particles of fluorine-containing polymer.

3. The polyimide film according to claim 1, wherein the first sub-layer has a thickness h1, the second sub-layer has a thickness h2, and the ratio h2/h1 is less than 0.1.

4. The polyimide film according to claim 1, wherein the first diamine component of the first polyimide contains fluorine atoms at a molar ratio greater than about 25 mol % of a total molar number of the first diamine component.

5. The polyimide film according to claim 4, wherein the second diamine component of the second polyimide contains fluorine atoms at a molar ratio greater than about 15 mol % of a total molar number of the second diamine component, or the second dianhydride component of the second polyimide contains fluorine atoms at a molar ratio greater than about 10 mol % of a total molar number of the second dianhydride component.

6. The polyimide film according to claim 1, wherein the first dianhydride component of the first polyimide contains fluorine atoms at a molar ratio greater than about 20 mol % of a total molar number of the first dianhydride component.

7. The polyimide film according to claim 6, wherein the second diamine component of the second polyimide contains fluorine atoms at a molar ratio greater than about 15 mol % of a total molar number of the second diamine component, or the second dianhydride component of the second polyimide contains fluorine atoms at a molar ratio greater than about 10 mol % of a total molar number of the second dianhydride component.

8. The polyimide film according to claim 1, wherein each of the first diamine component and the second diamine component is respectively selected from the group consisting of 4,4′-oxydianiline (4,4′-ODA), phenylenediamine (p-PDA), 2,2′-bis(trifluoromethyl)benzidine (TFMB), 1,3-bis(4-aminophenoxy)benzene (TPER), 1,4-bis(4-aminophenoxy)benzene (TPEQ), 2,2′-dimethyl[1,1′-biphenyl]-4,4′-diamine (m-TB-HG), 1,3′-bis(3-aminophenoxy)benzene (APBN), 3,5-diaminobenzo-trifluoride (DABTF), 2,2′-bis[4-(4-aminophenoxy)phenyl]propane (BAPP), 6-amino-2-(4-aminophenyl)benzoxazole (6PBOA), 5-amino-2-(4-aminophenyl)benzoxazole (5PBOA), 2,2-Bis(4-aminophenyl)hexafluoropropane (BIS-A-AF), 3,4-diaminofluorobenzene, 2-(trifluoromethyl)-1,4-phenylenediamine, 4-trifluoro-methyl-1,2-phenylenediamine, 1,2-diamine-4,5-difluorobenzene.

9. The polyimide film according to claim 1, wherein each of the first dianhydride component and the second dianhydride component is respectively selected from the group consisting of pyromellitic dianhydride (PMDA), 3,3′,4,4′-biphenyltetracarboxylic dianhydride (BPDA), [4-(3,4dicarboxyphenoxy)phenyl] propane dianhydride (BPADA), 2,2′-bis-(3,4-dicarboxyphenyl)hexafluoropropane dianhydride (6FDA), 4,4-oxydiphthalic anhydride (ODPA), benzophenonetetracarboxylic dianhydride (BTDA), 3,3′,4,4′-dicyclohexyltetracarboxylic acid dianhydride (HBPDA), 3,3′,4,4′-diphenylsulfonetertracarboxylic dianhydride (DSDA).

10. The polyimide film according to claim 1, wherein the particulate filler is selected from the group consisting of polyvinylfluoride (PVF), polyfluorinated vinylidene (PVDF) polymer, polytetrafluoroethylene (PTFE), polyfluorinated ethylene propylene (FEP), perfluoropolyether (PEPE), PFSA polymer, perfluoroalkoxy (PFA) polymer, chlorotrifluoroethylene (CTFE) polymer, ethylene chlorotrifuloroethylene (ECTFE) polymer.

11. The polyimide film according to claim 1, wherein the particulate filler has an average particle diameter between about 1 micrometers and about 10 micrometers.

12. The polyimide film according to claim 1, wherein the particulate filler is present in the first sub-layer in a quantity between about 30 wt % and about 45 wt % of a total weight of the first sub-layer.

13. The polyimide film according to claim 1, having at least one of the following properties: a dielectric constant Dₖ less than 3.04, a dissipation factor D_{f} less than 0.0107, a peel strength greater than 0.41.

14. The polyimide film according to claim 1, further comprising a third sub-layer connected with the first sub-layer, the first sub-layer being sandwiched between the second sub-layer and the third sub-layer.

15. The polyimide film according to claim 14, wherein the second sub-layer and the third sub-layer have a same polyimide composition.

16. The polyimide film according to claim 14, wherein the first sub-layer has a first thickness h1, the second sub-layer has a second thickness h2, the third sub-layer has a third thickness h3, and a sum h4 is defined as h2+h3, the ratio h4/h1 being less than 0.2.
